(19) United States
(12) Patent Application Publication
(10) Pub. No.: US 2017/0123710 A1
(43) Pub. Date: May 4, 2017

(54) DEDUPLICATION OF ENCRYPTED DATA

(71) Applicant: Longsand Limited, Cambridge (GB)

(72) Inventor: Justin Robert Fisher, Northborough, MA (US)

(21) Appl. No.: 14/928,355

(22) Filed: Oct. 30, 2015

(51) Int. Cl. G06F 3/06; H04L 9/32; H04L 9/08

(52) U.S. Cl. CPC G06F 3/0641; H04L 9/0838; G06F 3/0644; H04L 9/3247; H04L 9/3242; G06F 3/0619; G06F 3/0623; G06F 3/068

(57) ABSTRACT

Techniques are provided for deduplicating encrypted data. A method includes partitioning a data file into a plurality of data blocks. A block signature and a block key are calculated for one data block of the plurality of data blocks. The data block is encrypted using the block key. If the block signature for the encrypted data block matches the block signature for another encrypted data block, the encrypted data block is deleted and a link is created between a client and the other encrypted data block.

### BACKGROUND

Data storage can be significantly reduced by deduplication, the storing of a single copy of matching data blocks. Present techniques rely on the deduplication of unencrypted data blocks. These techniques are not secure as unauthorized users can access the unencrypted data blocks by directly accessing the storage medium.

### DESCRIPTION OF THE DRAWINGS

Certain exemplary examples are described in the following detailed description and in reference to the drawings, in which:

FIG. 1A is a schematic example of deduplicating encrypted data;

FIG. 1B is a schematic example of deduplicating encrypted data

FIG. 2A is an example of a system for deduplicating encrypted data;

FIG. 2B is an example of a system for deduplicating encrypted data;

FIG. 3A is a process flow diagram of an example method for deduplicating encrypted data;

FIG. 3B is a process flow diagram of an example method for deduplicating encrypted data;

FIG. 4A is a block diagram of an example memory resource storing non-transitory, machine readable instructions comprising code to direct one or more processing resources to deduplicate encrypted data; and

FIG. 4B is a block diagram of an example memory resource storing non-transitory, machine readable instructions comprising code to direct one or more processing resources to deduplicate encrypted data.

### DETAILED DESCRIPTION

Deduplication is a technique for eliminating duplicate copies of data. This technique provides improved storage utilization by reducing data storage needs. As a result, data storage costs may be decreased.

Encryption is the process of encoding data in such a way that unauthorized parties cannot access it. Authorized parties access the data by decrypting it using the key provided by the encrypting party. Encryption has improved data security and integrity.

Techniques are provided herein for the deduplication of encrypted data, which may decrease storage needs and improve the security of stored data. In some examples, a data file is partitioned into data blocks, and a block key and a block signature are calculated for each data block. For example, distinct hash codes may be calculated for the block key and the block signature. In one example, a mathematical compression of the data block may be used to obtain the block signature. In this manner, the block signature may be based on the contents of the data block. Hence, duplicate data blocks may have the same block signature while dissimilar data blocks may have different block signatures. The block key may be a random string of bits created solely for the purpose of encrypting and decrypting a data block. The block key is used to encrypt a data block.

The encrypted data block and its corresponding block signature are saved to a deduplication store. The block signature for the encrypted data block is compared to the block signatures of other encrypted data blocks stored in the deduplication store. If the block signature for the encrypted data block matches a block signature already present in the deduplication store, the encrypted data block is identified as a duplicate of another encrypted data block. The encrypted data block is deleted to avoid the storage of duplicate encrypted data blocks. A link is created between a client and the other encrypted data block having the same block signature as the deleted encrypted data block.

If the block signature for the encrypted data block does not match any block signatures in the deduplication store, the encrypted data block is identified as unique. The encrypted data block is left in the deduplication store.

In the above examples, the encrypted data block and its corresponding block signature are saved to a deduplication store prior to the comparison of block signatures. In other examples, the encrypted data block and its corresponding block signature remain in a virtual machine, or other client, while the block signature for the encrypted data block is compared to the block signatures of other encrypted data blocks stored in the deduplication store. For example, the data may be held in a cache memory while the calculations and comparisons are completed. The encrypted data block and its corresponding block signature are then moved to the deduplication store if the block signature for the encrypted data block does not match any of the block signatures already in the deduplication store. In this manner, an encrypted data block is not saved to the deduplication store unless it is unique, lowering bandwidth usage to the deduplication store.

In some examples, a file key may be used to encrypt the block key for the encrypted data block. For example, a single file key may be used to encrypt the block keys used to encrypt the data blocks partitioned from a data file. The encrypted block keys and the block signatures corresponding to the data file may then be saved in the deduplication store. In some examples, a user key may be employed to encrypt the single file key and the encrypted file key may be saved in the data deduplication store. In this manner, the file key, in encrypted form, is kept with the encrypted block keys it can decrypt.

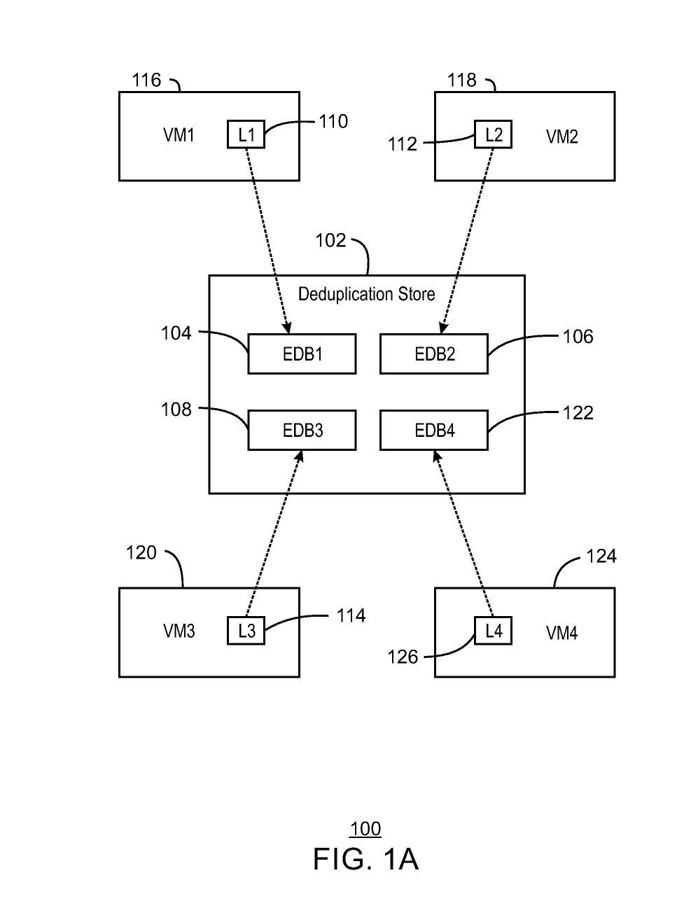

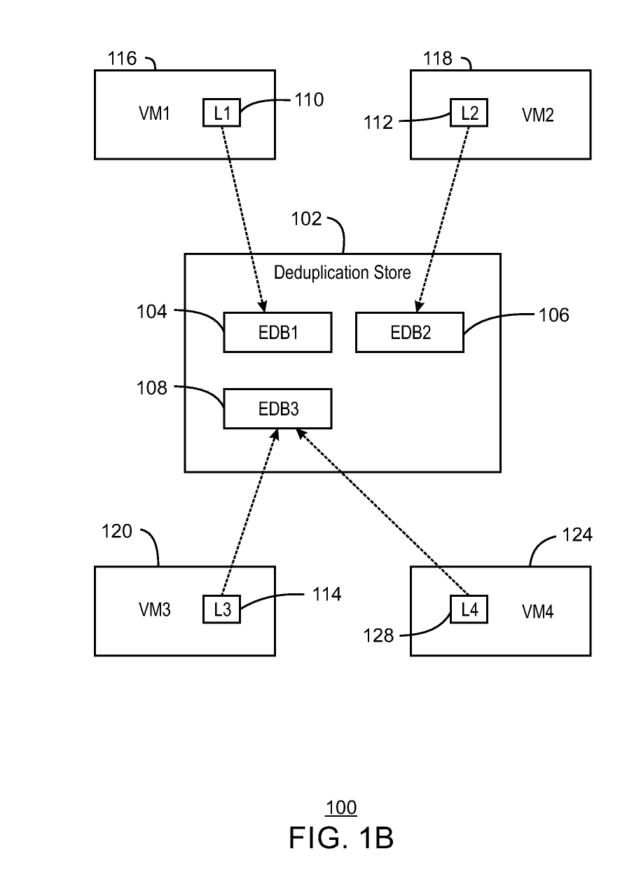

FIG. 1A is a schematic example 100 of deduplicating encrypted data. In this example, a deduplication store 102 contains encrypted data blocks EDB1 104, EDB2 106, and EDB3 108 and their corresponding block signatures (not shown). Links L1 110, L2 112, and L3 114 associate virtual machines VM1 116, VM2 118, and VM3 120 with EDB1 104, EDB2 106 and EDB3 108, respectively, in the deduplication store 102.

In this example, a new encrypted data block, EDB4 122, has just been saved by VM4 124, which holds a link, L4 126, to EDB4 122. The block signature of EDB4 122 can be compared to the block signatures of EDB1 104, EDB2 106, and EDB3 108. If it is determined that EDB4 122 does not have the same block signature as EDB1 104, EDB2 106, or EDB3 108, EDB4 122 is left in the deduplication store 102 as an additional data block.

If it is determined that EDB4 122 has the same block signature as another data block, e.g., EDB3 108, then EDB4 122 is deleted to avoid storing duplicate copies of data. This is the situation depicted in FIG. 1B.

FIG. 1B is a schematic example 100 of deduplicating encrypted data. Like numbered items are as described with respect to FIG. 1A. In this example, EDB4 122 (FIG. 1A) has been deleted because it has the same block signature as EDB3 108. Consequently, a new link, L4 128, is established to associate VM4 124 with EDB3 108.

It can be noted that the techniques described herein are not limited to working with virtual machines as clients, but may be used in any type of deduplication store in which encryption may be valuable. For example, the deduplication store may be used with individual e-mail accounts as clients, providing both efficient storage and encryption of stored information. Further, physical clients, such as computing clusters, may take advantage of the techniques.

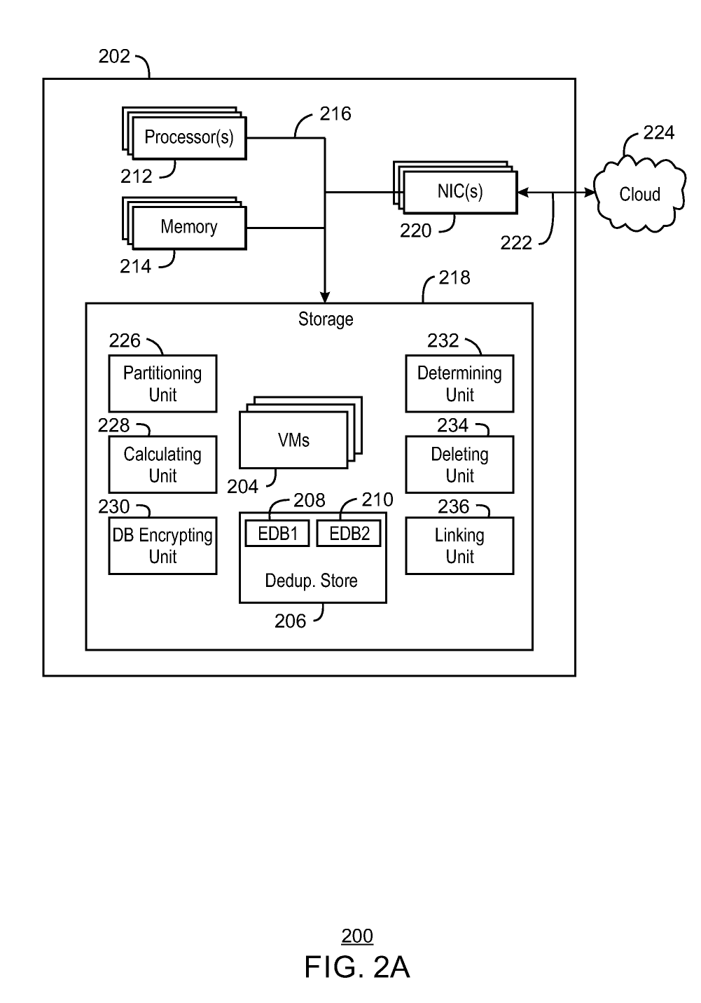

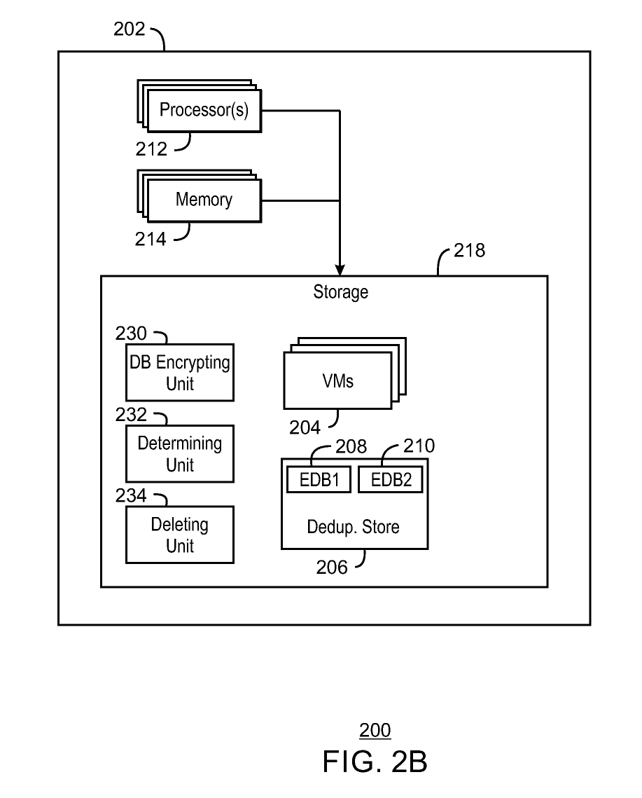

FIG. 2A is an example of a system 200 for deduplicating encrypted data. In this example, a server 202 may perform the functions described herein. The server 202 may host a number of virtual machines 204, as well as a deduplication store 206. The deduplication store 206 may include encrypted data blocks EDB1 208 and EDB2 210.

The server 202 may include a processing resource 212 that is to execute stored instructions, as well as a memory resource 214 that stores instructions that are executable by the processing resource 212. The processing resource 212 can be a single core processor, a dual-core processor, a multi-core processor, a number of processors, a computing cluster, a cloud sever, or the like. The processing resource 212 may be coupled to the memory resource 214 by a bus 216 where the bus 216 may be a communication system that transfers data between various components of the server 202. In examples, the bus 216 may include a Peripheral Component Interconnect (PCI) bus, an Industry Standard Architecture (ISA) bus, a PCI Express (PCIe) bus, high performance links, such as the Intel® direct media interface (DMI) system, and the like.

The memory resource 214 can include random access memory (RAM), e.g., static RAM (SRAM), dynamic RAM (DRAM), zero capacitor RAM, embedded DRAM (eDRAM), extended data out RAM (EDO RAM), double data rate RAM (DDR RAM), resistive RAM (RRAM), and parameter RAM (PRAM); read only memory (ROM), e.g., mask ROM, programmable ROM (PROM), erasable programmable ROM (EPROM), and electrically erasable programmable ROM (EEPROM); flash memory; or any other suitable memory systems.

The server 202 may also include a storage device 218. The storage device 218 may include non-volatile storage devices, such as a solid-state drive, a hard drive, a tape drive, an optical drive, a flash drive, an array of drives, or any combinations thereof. In some examples, the storage device 218 may include non-volatile memory, such as non-volatile RAM (NVRAM), battery backed up DRAM, and the like. In some examples, the memory resource 214 and the storage device 218 may be a single unit, e.g., with a contiguous address space accessible by the processing resource 212.

A network interface controller (NIC) 220 may also be linked to the processing resource 212. The NIC 220 may link the server 202 to a network 222, for example, to couple the server 202 to clients located in a computing cloud 224. In this manner, data stored in the computing cloud 224 may be accessed by the VMs 204, then encrypted and deduplicated.

The storage device 218 may include a number of units to provide the server 202 with the encryption and deduplication functionalities. The units may be software modules, hardware encoded circuitry, or a combination thereof. For example, a partitioning unit 226 may partition a data file into a plurality of data blocks. A calculating unit 228 may calculate a block key and a block signature for a data block. Distinct hash codes may be calculated for the block key and the block signature. The block key may be a random string of bits created solely for the purpose of encrypting and decrypting a data block. In contrast, a block signature is the result of a mathematical compression of the data block. In this manner, the block signature is based on the contents of the data block. Block signatures may be 256 bits long to lower the probability that dissimilar data blocks will have the same block signature. Block signatures may be stored in a block signature table contained in the deduplication store 206.

A data block encrypting unit 230 may encrypt a data block using the calculated block key. A determining unit 232 may access the deduplication store 206 to determine if the encrypted data block has the same block signature as another encrypted data block. If the encrypted data block has the same block signature as another encrypted data block, a deleting unit 234 may delete the encrypted data block. The deleting unit 234 deletes the encrypted data block to ensure that multiple copies of the same encrypted data block are not saved. A linking unit 236 may associate the other encrypted data block with the virtual machine 204 that was initially linked to the deleted encrypted data block.

If the encrypted data block does not have the same block signature as another encrypted data block, the contents of the encrypted data blocks may not be the same. In this case, one of the VMs 204 has already stored the encrypted data block to the deduplication store 206 and created a link between the encrypted data block and its associated virtual machine.

A block key encrypting unit may encrypt the block key for the stored encrypted data block with a randomly generated file key. A single file key may be used to encrypt the block keys for the encrypted data blocks corresponding to the data blocks that make up the original data file. The block key encrypting unit may also save the encrypted block key in the deduplication store 206. The encrypted block key, along with its corresponding block signature, may be saved in a file manifest table located in the deduplication store 206. In this manner, the encrypted block keys and the block signatures corresponding to the original data file may be stored in one place.

A file key encrypting unit may employ a user key to encrypt the file key which was used to encrypt the block keys for the encrypted data blocks corresponding to the original data file. The encrypted file key may be stored in the deduplication store 206. In this manner, the file key, in encrypted form, may be saved with the encrypted block keys it can decrypt.

Access to the original data file may be accomplished by employing the user key to decrypt the encrypted file key. The unencrypted file key may be used to decrypt the encrypted block keys. The unencrypted block keys may be used to decrypt the encrypted data blocks stored in the deduplication store.

In a client-server configuration, the user key may remain on the client and may not be disclosed to the server. The file key and block keys may be kept on the server, but in encrypted form, thus maintaining the secure status of the data file contents.

The block diagram of FIG. 2A is not intended to indicate that the system 200 for deduplicating encrypted data must include all the components shown in the figure. For example, the partitioning unit 226, the calculating unit 228, and the linking unit 236 may not be used in some implementations, as shown in the example in FIG. 2B. Further, any number of additional units may be included within the system 200 for deduplicating encrypted data, depending on the details of the specific implementation. For example, encrypting units may need to be added to the system 200 if the block key is encrypted with a file key and the file key is encrypted with a user key.

FIG. 2B is an example of a simplified system 200 for deduplicating encrypted data. Like numbered units are as described with respect to FIG. 2A. Not all items may be present in all examples. For example, as shown in FIG. 2B, a simplified system may include a data block encrypting unit 230, a determining unit 232, and a deleting unit 234. Other units may not be used in some examples, such as the partitioning unit 226, the calculating unit 228, and the linking unit 236.

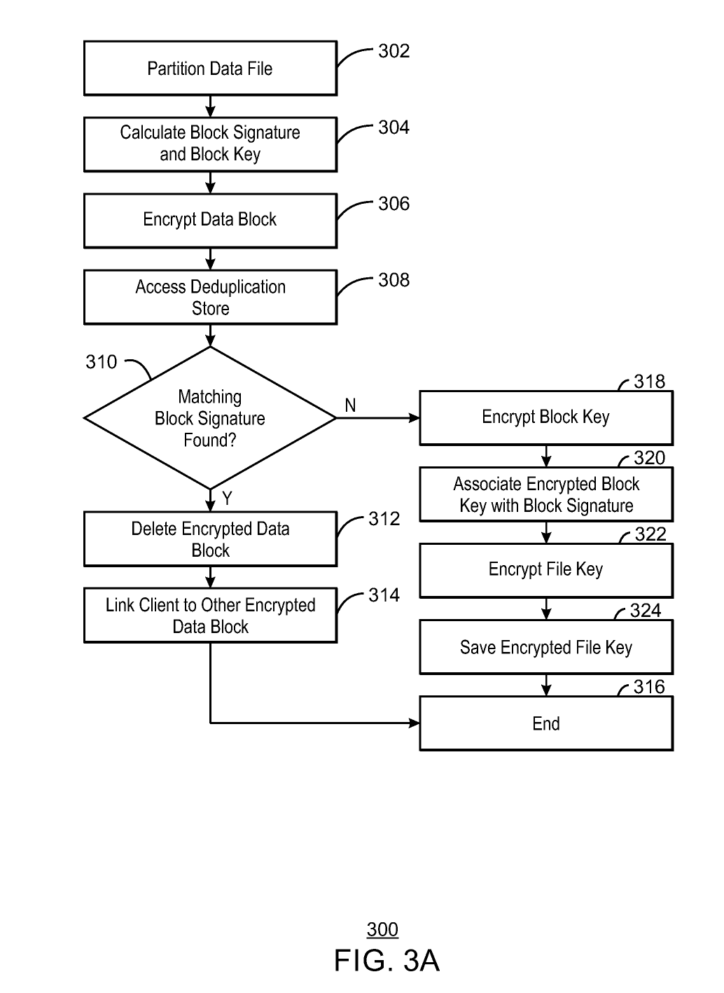

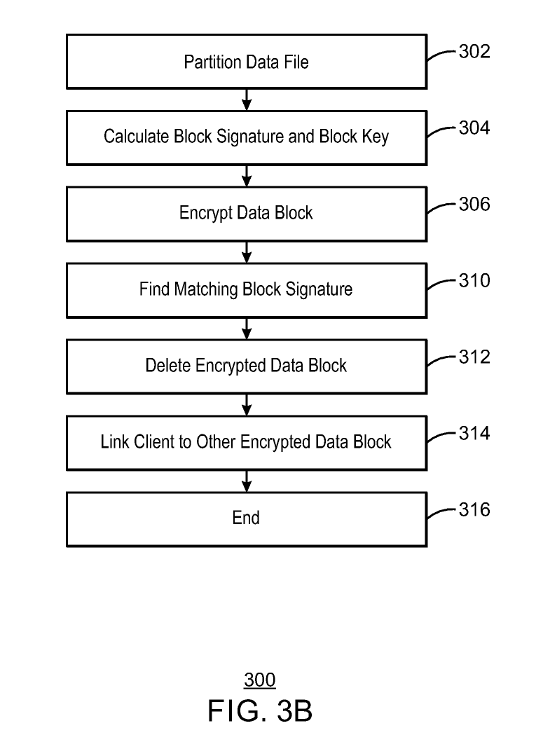

FIG. 3A is a process flow diagram of an example method 300 for deduplicating encrypted data. The method 300 may be performed by the system 200 for deduplicating encrypted data described with respect to FIG. 2A. In this example, the method 300 begins at block 302 with the partitioning of a data file into a plurality of data blocks. At block 304, a block signature and a block key are calculated for a data block. At block 306, the data block is encrypted using the block key calculated at block 304. A deduplication store is accessed at block 308. At block 310, the block signature for the encrypted data block is compared to other block signatures in the deduplication store to determine if a block signature in the deduplication store matches the block signature for the encrypted data block.

If a matching block signature is found at block 310, the method 300 proceeds to block 312 where the encrypted data block is deleted. At block 314, a link is created between the other encrypted data block and the client that was previously associated with the encrypted data block. The method 300 then ends at block 316.

If a matching block signature is not found at block 310, the method 300 proceeds to block 318 where the block key for the encrypted data block is encrypted with a file key. Then, at block 320, the encrypted block key is associated with the block signature for the encrypted data block in the deduplication store. A user key is employed at block 322 to encrypt the file key which was used at block 318 to encrypt the block key. At block 324, the encrypted file key is saved in the deduplication store. The method 300 then ends at block 316.

The process flow diagram of FIG. 3A is not intended to indicate that the method 300 for the deduplication of encrypted data must include all the blocks shown in the figure. For example, blocks 318-324 may not be used in some implementations, as shown in the example in FIG. 3B. Further, any number of additional blocks may be included within the method 300, depending on the details of the specific implementation. For example, blocks may need to be added to the method 300 if the file key is encrypted with a workspace key and the workspace key is encrypted with the user key.

FIG. 3B is a process flow diagram of an example method 300 for the deduplication of encrypted data. Like numbered items are as described with respect to FIG. 3A. Not all blocks will be present in all examples. For example, as shown in FIG. 3B, a simplified method 300 may include blocks 302-306 and 310-316 and may not include various blocks, such as blocks 318-324.

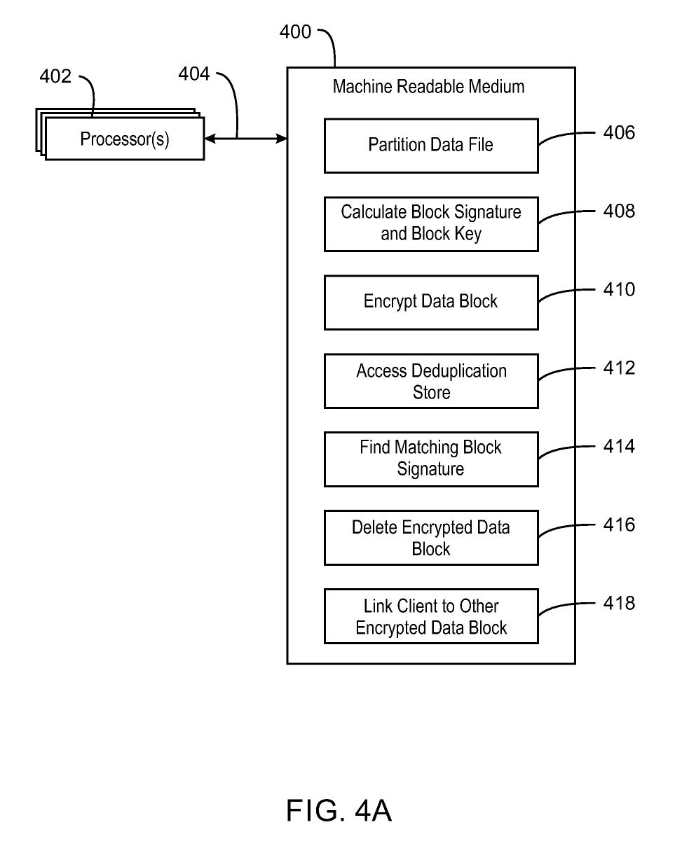

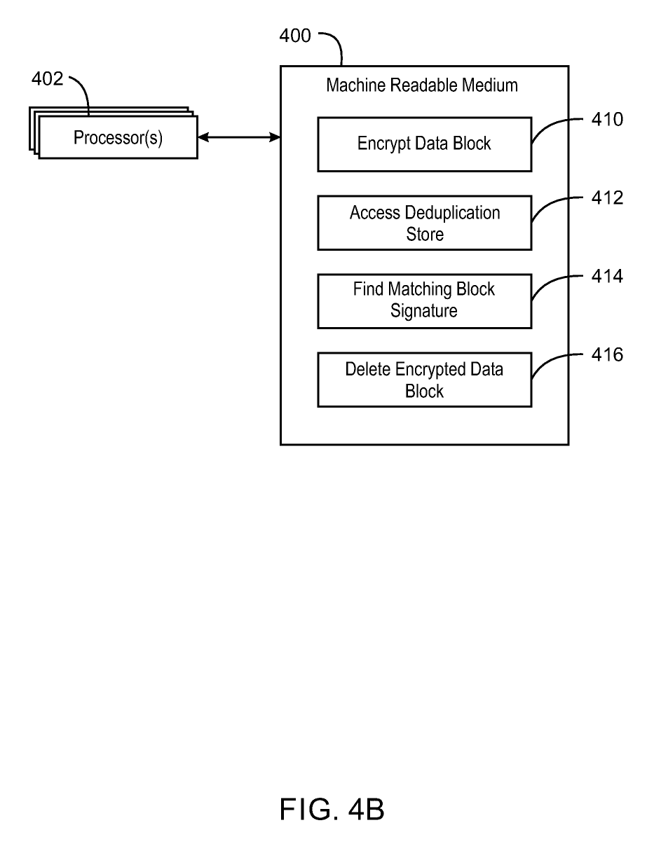

FIG. 4A is a block diagram of an example memory resource 400 storing non-transitory, machine readable instructions comprising code to direct one or more processing resources to deduplicate encrypted data. The memory resource 400 is coupled to one or more processing resources 402 over a bus 404. The processing resource 402 and bus 404 may be as described with respect to the processing resource 212 and bus 216 of FIG. 2A.

The memory resource 400 includes a block of code 406 to direct one of the one or more processing resources 402 to partition a data file into a plurality of data blocks. Another block of code 408 directs one of the one or more processing resources 402 to calculate a block signature and a block key for a data block. The memory resource 400 also includes a block of code 410 to direct one of the one or more processing resources 402 to encrypt the data block using the block key. A block of code 412 may direct one of the one or more processing resources 402 to access the deduplication store. Further, a block of code 414 may direct one of the one or more processing resources 402 to find the block signature of another encrypted data block that matches the block signature of the encrypted data block. A block of code 416 may be included to direct one of the one or more processing resources 402 to delete the encrypted data block so that duplicate data is not stored. A block of code 418 may direct one of the one or more processing resources 402 to link a client to the other encrypted data block.

The code blocks described above do not have to be separated as shown; the functions may be recombined into different blocks that perform the same functions. Further, the machine readable medium does not have to include all of the blocks shown in FIG. 4A. However, additional blocks may have to be added. The inclusion or exclusion of specific blocks is dictated by the presence or absence of matching block signatures. Certain code blocks are included when matching block signatures are found and different code blocks are included when matching block signatures are not found. For example, when matching block signatures are not found, code blocks 414-418 may be excluded and additional blocks may be needed to direct one of the one or more processing resources 402 to encrypt the block key with a file key, encrypt the file key with a user key, and save the encrypted file key in the deduplication store.

FIG. 4B is another block diagram of the example memory resource 400 that stores non-transitory, machine readable instructions comprising code to direct one or more processing resources 402 to deduplicate encrypted data. Like numbered items are as described with respect to FIG. 4A. This simpler arrangement includes code blocks that may be used to perform the basic functions in some of the examples described herein.

While the present techniques may be susceptible to various modifications and alternative forms, the exemplary examples discussed above have been shown only by way of example. It is to be understood that the techniques are not intended to be limited to the particular examples disclosed herein. Indeed, the present techniques include all alternatives, modifications, and equivalents falling within the scope of the present techniques.

What is claimed is:

1. A method for deduplicating encrypted data, comprising:
partitioning a data file into a plurality of data blocks;
calculating a block signature and a block key for one data block of the plurality of data blocks;
encrypting the data block using the block key to form an encrypted data block; and if the block signature for the encrypted data block matches a block signature for another encrypted data block:
deleting the encrypted data block from a deduplication store; and
creating a link between a client and the other encrypted data block.

2. The method of claim 1, wherein calculating the block signature and the block key for the data block comprises calculating a hash code for the data block.

3. The method of claim 2, wherein calculating the hash code comprises using a mathematical compression of the data block to obtain the block signature.

4. The method of claim 1, comprising storing the encrypted data block to the deduplication store.

5. The method of claim 1, comprising accessing the deduplication store to determine if the block signature for the encrypted data block matches the block signature for the other encrypted data block.

6. The method of claim 1, comprising, if the block signature for the encrypted data block does not match the block signature for the other encrypted data block, storing the encrypted data block in the deduplication store to form a stored encrypted data block.

7. The method of claim 6, comprising:
encrypting the block key for the stored encrypted data block with a file key to form an encrypted block key; and
encrypting the file key with a user key to form an encrypted file key.

8. The method of claim 7, comprising associating the block signature and the encrypted block key for the stored encrypted data block in the deduplication store.

9. The method of claim 8, comprising saving the encrypted file key with the block signature and the encrypted block key for the stored encrypted data block.

10. A system for deduplicating encrypted data, comprising:
a processing resource; and
a memory resource storing machine readable instructions to cause the processing resource to:
encrypt a data block using a block key to form an encrypted data block;
access a deduplication store to determine if a block signature for the encrypted data block matches a block signature for another encrypted data block; and
delete the encrypted data block from the deduplication store if the block signature for the encrypted data block matches the block signature for the other encrypted data block.

11. The system of claim 10, comprising:
partitioning a data file into a plurality of data blocks; and
calculating a block signature and the block key for one data block of the plurality of data blocks.

12. The system of claim 10, comprising linking a client to the other encrypted data block.

13. The system of claim 10, comprising storing the encrypted data block to form a stored encrypted data block if the block signature for the encrypted data block does not match the block signature for the other encrypted data block.

14. The system of claim 13, comprising:
encrypting the block key for the encrypted data block with a file key to form an encrypted block key; and
encrypting the file key with a user key to form an encrypted file key.

15. The system of claim 14, comprising saving the encrypted file key with the block signature for the encrypted data block and the encrypted block key in the deduplication store.

16. A non-transitory, machine readable medium comprising code for deduplicating encrypted data, the code to direct a processing resource to:
encrypt a data block using a block key to form an encrypted data block;
access a deduplication store to determine if a block signature for the encrypted data block matches a block signature for another encrypted data block; and
delete the encrypted data block from the deduplication store if the block signature for the encrypted data block matches the block signature for the other encrypted data block.

17. The non-transitory, machine readable medium of claim 16, comprising code to direct the processing resource to:
partition a data file into a plurality of data blocks; and
calculate a block signature and the block key for one data block of the plurality of data blocks.

18. The non-transitory, machine readable medium of claim 16, comprising code to direct the processing resource to link a client to the other encrypted data block.

19. The non-transitory, machine readable medium of claim 16, comprising code to direct the processing resource to store the encrypted data block to form a stored encrypted data block if the block signature for the encrypted data block does not match the block signature for the other encrypted data block.

20. The non-transitory, machine readable medium of claim 19, comprising code to direct the processing resource to:
encrypt the block key for the encrypted data block with a file key to form an encrypted block key;
encrypt the file key with a user key to form an encrypted file key; and
save the encrypted file key with the block signature for the encrypted data block and the encrypted block key in the deduplication store.
